(19) United States
(12) Patent Application Publication
(10) Pub. No.: US 2004/0215991 A1
(43) Pub. Date: Oct. 28, 2004

(54) Power-up of multiple processors when a voltage regulator module has failed

(75) Inventors: Martin McAfee, Lago Vista, TX (US); Bharath Vasudevan, Austin, TX (US)

Correspondence Address: Paul N. Katz, Baker Botts L.L.P., One Shell Plaza, 910 Louisiana Street, Houston, TX, 77002-4995, US

(73) Assignee: Dell Products L.P.

(21) Appl. No.: 10/421,277

(22) Filed: Apr. 23, 2003

(51) Int. Cl. G06F 1/26

(52) U.S. Cl. 713/324; 713/330

(57) ABSTRACT

In an information handling system, voltage regulator modules (VRM) are first enabled and determined to be operational before enabling an associated processor. If a VRM is determined not to be operational, then the associated processor is disabled. Once all VRMs are determined to be operational or not operational and the associated processors are enabled or disabled as the case may be, the information handling system is operationally started-up with all operational VRMs and associated processors functioning.

### BACKGROUND OF THE INVENTION TECHNOLOGY

1. Field of the Invention

The present invention is related to information handling systems, and more specifically, to maintaining operation of the information handling system having multiple processors when a voltage regulator module for a one of the multiple processors has failed.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems, e.g., computer, personal computer workstation, portable computer, computer server, print server, network router, network hub, network switch, storage area network disk array, RAID disk system and telecommunications switch.

Recent trends in information handling systems such as workstations, computer servers and associated storage disk arrays are being developed with multiple central processing units (CPUs) or microprocessors for increased computational power and data processing throughput. Modern high-speed microprocessors require fast delivery of enormous supply currents in microsecond time frames, tight supply-voltage tolerance, and intelligent voltage programming. This is accomplished with a Voltage Regulator Module (VRM) for each high-speed microprocessor. Certain microprocessors, e.g., PENTIUM III and CELERON (trademarks of Intel Corporation) require power supplies that meet the VRM 8.4 standard which requires programmable voltages of from 1.5 to 2.05V, with a typical static variation of ±3.5% and a dynamic variation of ±7% with a slew rate of 20 A/μsecond at full-load excursions. For newer and more powerful microprocessors, the VRM 9.0 standard is even more demanding in that the transient voltage regulation specification is 0/−7% with slew rates as high as 50 A/μsecond. The VRM may be either a plug-in module or part of the information handling system motherboard (or daughter board) on which the microprocessor is connected to with a socket.

If a VRM fails, it must be replaced. A plug-in VRM may be replaced by shutting down the information handling system, removing the failed VRM and then replacing it with a new VRM. The information handling system is then powered-up and reboots to an operating condition. When a failed VRM is part of (components or module board soldered to) the motherboard (or daughterboard), the entire motherboard (or daughterboard) must removed, and a substitute motherboard (or daughterboard) installed in its place before the information handling system may be powered-up and rebooted to an operating condition. Either configuration of the VRM requires the intervention of a technician, disassembly of the information handling system, and down time for the information handling system of a time duration determined by the distance the technician must travel, the availability of a replacement VRM, or a substitute motherboard (or daughterboard).

Therefore, a problem exists, and a solution is required for improving the operational availability of the information handling system when a VRM fails.

### SUMMARY OF THE INVENTION

The present invention remedies the shortcomings of the prior art by providing a method, system and apparatus, in an information handling system, for operating multiple processors when a voltage regulator module has failed. An information handling system may have at least two distinct power planes for providing, for example but not limited to, up to four CPUs (microprocessors) in a node. The information handling system may have two or more nodes. In the event of a critical or catastrophic failure, e.g., CPU/memory bank/BIOS failure, the information handling system can reboot and come back to an operating condition, but in a degraded mode. The degraded mode means that the information handling system is still operationally available, but with the failed node disabled, e.g., four of the processors are not functioning (of the failed node). Another catastrophic failure is when a VRM of a node causes a short circuit on the incoming power bus, thus denying power to the remaining VRMs of the node. This failure will also disable the entire node from further operation until repaired or replaced. However, if the VRM failures without the failure shorting out the incoming power bus, then this failure is localized to that VRM and associated processor, and therefore will not be a catastrophic event that requires disabling the entire node of processors.

According to exemplary embodiments of the present invention, when a VRM fails without causing loss of power to the other operational VRMs of the node, the processor, associated with the failed VRM, will be held in RESET and will not run when the information handling system is powered back up. This feature provides the capability to reboot the information handling system and have all of the functional processors/VRMs remain active and available even though one of the processors of a node has been disabled. The defective plug-in VRM or motherboard (or daughterboard) will eventually require replacement, but operation of the information handling system will only be degraded as to the failed VRM.

In an exemplary embodiment of the present invention, a logic controller may be used, e.g., complex programmable logic device (CPLD), application specific integrated circuit (ASIC), etc. As an example, the logic controller controls an enable signal to each of the VRMs. During system start-up, the logic controller initiates turn-on of each VRM and then waits a programmable time limit for each of the VRMs to return a power good signal response. The logic controller may sequentially initiate turn-on of each VRM and then wait for the power good signal response from the respective VRM, or the logic controller may initiate turn-on of all VRMs and then wait for power good signal responses from each of the VRMs. An advantage of sequentially turning on each of the VRMs is a more gradual power-up loading to the system power source without causing a possibly large surge condition if all of the VRMs were turned-on at the same time.

When all of the VRMs have been turned on and all of the VRMs have returned power good signals, then the information handling system will be allowed to boot-up to an operating condition. However, if one or more of the VRMs do not return a power good signal, then the logic controller will disable the processor(s) (e.g., hold the processor(s) in RESET) associated with the VRM(s) not returning the power good signal. After the appropriate processor(s) has been disabled, the information handling system will be allowed to boot-up to the operational condition.

A technical advantage of the present invention is determining proper operation of a VRM before system boot-up. Another technical advantage is disabling only those processors associated with a non-functional VRM. Another technical advantage is greater up time for the information handling system and repair thereof at more convenient times.

Other technical advantages of the present disclosure will be readily apparent to one skilled in the art from the following figures, descriptions, and claims. Various embodiments of the invention obtain only a subset of the advantages set forth. No one advantage is critical to the invention.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a schematic block diagram of an exemplary embodiment of an information handling system;

FIG. 2 is a schematic block diagram of a processor, associated voltage regulator module (VRM) and power controller, according to an exemplary embodiment of the present invention;

FIG. 3 is a schematic flow diagram of operational steps of an exemplary embodiment of the present invention; and

FIG. 4 is a schematic flow diagram of operational steps of another exemplary embodiment of the present invention.

The present invention may be susceptible to various modifications and alternative forms. Specific exemplary embodiments thereof are shown by way of example in the drawing and are described herein in detail. It should be understood, however, that the description set forth herein of specific embodiments is not intended to limit the present invention to the particular forms disclosed. Rather, all modifications, alternatives, and equivalents falling within the spirit and scope of the invention as defined by the appended claims are intended to be covered.

### DETAILED DESCRIPTION OF SPECIFIC EMBODIMENTS

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU), hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring now to the drawings, the details of an exemplary embodiment of the present invention are schematically illustrated. Like elements in the drawings will be represented by like numbers, and similar elements will be represented by like numbers with a different lower case letter suffix.

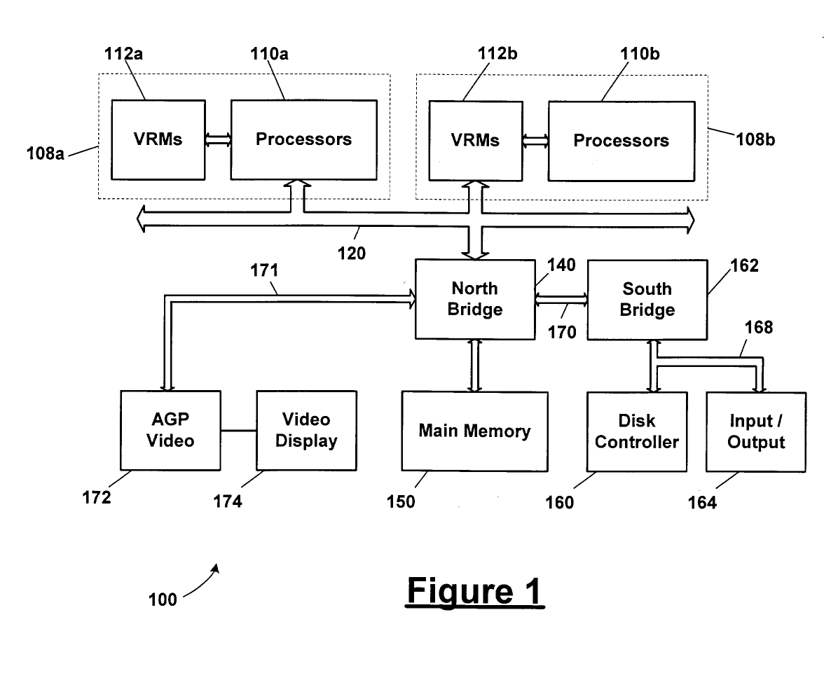

Referring to FIG. 1, depicted is an information handling system having electronic components mounted on at least one printed circuit board (PCB) (not shown) and communicating data and control signals therebetween over signal buses. In one embodiment, the information handling system is a computer system. The information handling system, generally referenced by the numeral 100, comprises processors 110 and associated voltage regulator modules (VRMs) 112 configured as a processor node 108. There may be one or more processor nodes 108 (two nodes 108a and 108b are illustrated). A north bridge 140, which may also be referred to as a “memory controller hub” or a “memory controller,” is coupled to a main system memory 150. The north bridge 140 is coupled to the processors 110 via the host bus 120. The north bridge 140 is generally considered an application specific chip set that provides connectivity to various buses, and integrates other system functions such as memory interface. For example, an Intel 820E and/or 815E chip set, available from the Intel Corporation of Santa Clara, Calif., provides at least a portion of the north bridge 140. The chip set may also be packaged as an application specific integrated circuit (“ASIC”). The north bridge 140 typically includes functionality to couple the main system memory 150 to other devices within the information handling system 100. Thus, memory controller functions such as main memory control functions typically reside in the north bridge 140. In addition, the north bridge 140 provides bus control to handle transfers between the host bus 120 and a second bus(es), e.g., PCI bus 170 and AGP bus 171, the AGP bus 171 being coupled to video display 174. The second bus may also comprise other industry standard buses or proprietary buses, e.g., ISA, SCSI, USB buses 168 through a south bridge (bus interface) 162. These secondary buses 168 may have their own interfaces and controllers, e.g., ATA disk controller 160 and input/output interface(s) 164.

In the information handling system 100, according to the present invention, a plurality of nodes 108 (depicted as nodes 108a and 108b) may comprise a plurality of processors 110, e.g., four, and an associated VRM 112 for each of the processors 110. Each node 108 may have a power and a ground plane for coupling power to the VRMs 112. The VRMs are used to generate appropriate operating voltages for the processors 108. State of the art processors have very demanding voltage regulation and current draw requirements. The VRMs 112 may be plug-in modules, may be attached to a motherboard of the system 100, or may be part of daughterboards (not shown) of the nodes 108.

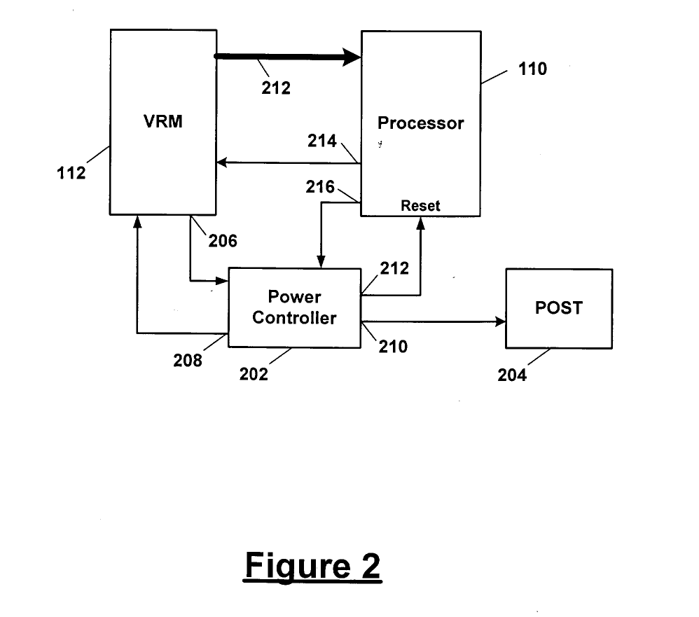

Referring now to FIG. 2, depicted is a schematic block diagram of a processor, associated voltage regulator module (VRM) and power controller, according to an exemplary embodiment of the present invention. The processor 110 receives power from the VRM 112 of the correct voltage and current over the power bus 212. The processor 110 can request a desired voltage from the VRM 112 over a voltage request bus 214. A power controller 202 controls the turn-on of the VRM 112 with power enable signal line 208. The power controller 202 receives a “power good output” signal from the VRM 112 over a power good signal line 206. The power controller 202 can hold the processor 110 in a RESET condition over a processor reset signal line 212. The power controller 202 also can signal to a power on reset (POST) logic 204 of the information handling system that the VRM 112 has powered up properly and that the processor 110 has been enabled for a system boot sequence of the information handling system 100. Each of the processors 110 and VRMs 112 of a node 108 may be coupled to an associated power controller 202 for the node. In the alternative, one power controller 202 may be used to monitor and control all of the processors 110 and VRMs 112 of the nodes 108. A thermal trip condition of the processor 110 may also be monitored, for example, by the power controller 202 reading thermal trip signal line 216.

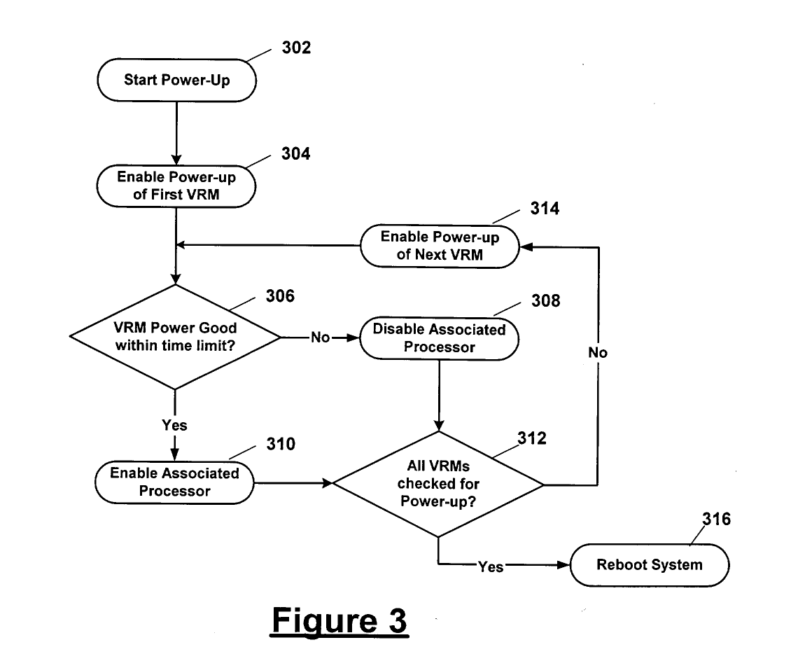

Referring to FIG. 3, depicted is a schematic flow diagram of operational steps of an exemplary embodiment of the present invention. Upon power-up of the information handling system 100 (FIG. 1), step 302 initiates powering-up the VRMs 112. In step 304, a first one of the VRMs 112 is powered-up. Then step 306 expects an acknowledgement (e.g., a power good signal) within a certain time limit, e.g., about 150 milliseconds, from the VRM 112 that it is working properly (from the VRM 112 just powered-up in step 304). If the power good signal is received within the certain time limit from the just powered-up VRM 112 (i.e., the VRM 112 is functioning properly), then its associated processor 110 is enabled in step 310. If the power good signal is not received within the certain time limit from the just powered-up VRM 112 (i.e., the VRM 112 is not functioning properly), then its associated processor 110 is disabled in step 308.

Step 312 determines whether all of the VRMs 112 have been powered-up. If any VRMs 112 have not yet been powered-up, then step 314 will enable the next (remaining) VRM 112. Then step 306 again waits for an acknowledgement (e.g., a power good signal) within a certain time limit from the VRM 112 that it is working properly (from the VRM 112 just powered-up in step 314). If the power good signal is received within the certain time limit from the just powered-up VRM 112 (i.e., the VRM 112 is functioning properly), then its associated processor 110 is enabled in step 310. If the power good signal is not received within the certain time limit from the just powered-up VRM 112 (i.e., the VRM 112 is not functioning properly), then its associated processor 110 is disabled in step 308. Once all of the VRMs have been enabled, checked to see if the power good signal has been asserted within the certain time limit, and the associated processors been enabled or disabled as the case may be, step 316 initiates a reboot of the information handling system 100. Thus, only the processor(s) 110 that do not have a properly operating VRM 112 are disabled. The other processors 110 having operational VRMs 112 may be utilized in the operating information handling system.

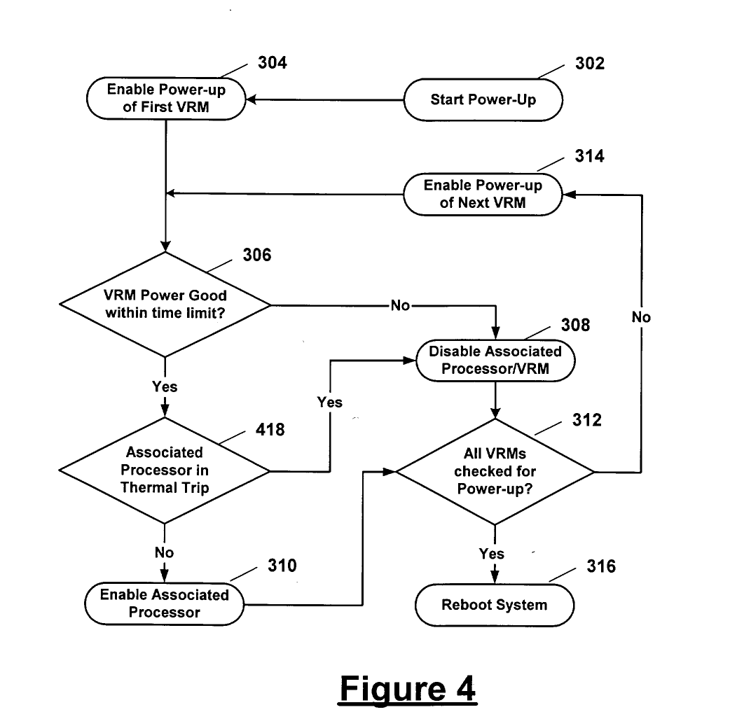

Referring to FIG. 4, depicted is a schematic flow diagram of operational steps of another exemplary embodiment of the present invention. The operation of this exemplary embodiment is as described above for the embodiment depicted in FIG. 3, with the addition of step 418 which determines whether a processor 110 is in thermal overload (trip). In this embodiment, a VRM 112 may be functional, but if there is a problem with its associated processor 110, e.g., fan failure, shorted input/output nodes, catastrophic internal malfunction, etc., then the defective processor 110 is disabled. In addition, the VRM 112 of the defective processor may be disabled so that power is no longer supplied to the defective processor 110. Thus, the information handling system may function with all available good VRMs 112 and associated processors 110.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. An information handling system having a plurality of processors and a plurality of voltage regulator modules associated therewith, said system comprising:
a plurality of processors;
a plurality of voltage regulator modules, each of said plurality of voltage regulator modules supplying operating voltages to associated ones of said plurality of processors; and
a power controller, wherein said power controller enables each of said plurality of voltage regulator modules, checks each enabled one of said plurality of voltage regulator modules for proper operation, and enables each of said plurality of processors that is associated with a properly operating one of said plurality of voltage regulator modules.

2. The information handling system according to claim 1, wherein the information handling system is selected from the group consisting of a computer system, a data storage system, a personal computer workstation, a portable computer, a computer server, a print server, a network router, a network hub, a network switch, a storage area network disk array, a RAID disk system and a telecommunications switch.

3. The information handling system according to claim 1, wherein said power controller is selected from the group consisting of a complex programmable logic device (CPLD) and an application specific integrated circuit (ASIC).

4. The information handling system according to claim 1, wherein said plurality of processors, said plurality of voltage regulator modules and said power controller are connected on a printed circuit board (PCB).

5. The information handling system according to claim 4, wherein the printed circuit board is a motherboard.

6. The information handling system according to claim 5, wherein each of said plurality of voltage regulator modules are on separate daughterboards, and each daughterboard is coupled to the motherboard.

7. The information handling system according to claim 1, wherein said plurality of processors are grouped into at least two processor nodes.

8. The information handling system according to claim 1, wherein said power controller is a plurality of power controllers, each of said plurality of power controllers is associated with corresponding ones of said plurality of voltage regulator modules and said plurality of processors.

9. The information handling system according to claim 1, wherein said power controller enables each of said plurality of voltage regulator modules and verifies that each enabled one of said plurality of voltage regulator modules returns a power good signal within a certain time limit.

10. The information handling system according to claim 9, wherein the certain time limit is about 150 milliseconds.

11. The information handling system according to claim 1, wherein said power controller initiates a power-on self test boot-up of said information handling system after enabling and checking each of said plurality of voltage regulator modules.

12. The information handling system according to claim 1, wherein said power controller disables a processor associated with a non-operating voltage regulator module.

13. The information handling system according to claim 1, wherein said power controller determines whether any of said plurality of processors are in thermal overload.

14. A method for power-up of multiple processors in an information handling system, said method comprising the steps of:
a) enabling a first voltage regulator module;
b) determining whether the enabled first voltage regulator is operational;
c) enabling a first processor if the enabled first voltage regulator is operational, otherwise disabling the first processor;
d) enabling another voltage regulator module;
e) enabling another processor if the enabled another voltage regulator is operational, otherwise disabling the another processor;
f) determining whether all voltage regulator modules have been enabled, if not then repeating steps d) through f) and if so then;
g) enabling an information handling system start-up.

15. The method according to claim 14, wherein the steps of determining whether enabled voltage regulators are operational comprises the steps of determining whether a power good signal is returned from each of the enabled voltage regulators.

16. The method according to claim 15, wherein the steps of determining whether enabled voltage regulators are operational further comprise the steps of determining whether the power good signal is returned from each of the enabled voltage regulators within a certain time limit.

17. The method according to claim 16, wherein the certain time limit is about 150 milliseconds.

18. The method according to claim 14, wherein the step of enabling an information handling system start-up comprises the step of power-on self-test (POST) of the information handling system.

19. The method according to claim 14, wherein the steps of disabling the processors comprise the steps of holding the disabled processors in reset.

20. The method according to claim 14, further comprising the steps of determining whether the processors are in thermal overload.

21. The method according to claim 20, further comprising the step of disabling the processors in thermal overload.

22. The method according to claim 21, further comprising the step of disabling voltage regulator modules that are associated with the processors in thermal overload.
